(19) United States
(12) Patent Application Publication
(10) Pub. No.: US 2020/0398433 A1
(43) Pub. Date: Dec. 24, 2020

(54) METHOD OF CALIBRATING A MOBILE MANIPULATOR

(71) Applicant: THE GOVERNING COUNCIL OF THE UNIVERSITY OF TORONTO, Toronto (CA)

(72) Inventors: Jonathan Scott Kelly, Toronto (CA); Oliver Limoyo, York (CA); Trevor Ablett, Toronto (CA)

(21) Appl. No.: 16/976,066

(22) PCT Filed: Mar. 1, 2019
(86) PCT No.: PCT/CA2019/050252

§ 371 Date: Aug. 26, 2020

Related U.S. Application Data
(60) Provisional application No. 62/637,282, filed on Mar. 1, 2018.

(51) Int. Cl. B25J 9/16; B25J 9/04; B25J 13/08; B25J 19/02

(52) U.S. Cl. CPC B25J 9/1692; B25J 9/162; B25J 19/023; B25J 13/085; B25J 9/046

(57) ABSTRACT

A method is provided for calibrating a manipulator and an external sensor. The method includes generating a first cloud map using depth information collected using a depth sensor, and generating a second cloud map using contact information collected using a contact sensor, which is coupled to an end effector of the manipulator. Thereafter, the first cloud map and the second cloud map are aligned to recover extrinsic parameters using the iterative closest point algorithm. The depth sensor is stationary relative to a base frame of the manipulator, and the depth information corresponding to a rigid structure is collected by capturing depth information from multiple vantage points by navigating the manipulator. The contact information is collected by moving an end effector of the manipulator over the rigid structure.

### FIELD OF THE INVENTION

In general, the subject matter disclosed herein relates to robot manipulators. More particularly, but not exclusively, the subject matter relates to calibration of relative position and orientation of an external sensor to the base and end-effector of the robot manipulator.

### BACKGROUND

Collaborative mobile manipulators have the potential to become ubiquitous outside of factory environments, if certain challenges are addressed. One among those challenges corresponds to calibration. Calibration, depending on the platform, may involve determining intrinsic (e.g., camera focal length) and extrinsic (i.e., relative pose) sensor parameters, as well as kinematic parameters of the manipulator arm (e.g., joint biases and link length offsets).

Currently, person-safe robot manipulators, be it fixed-base units or mobile, and the vision sensors upon which they rely, require tedious manual calibration upon installation. This is necessary to ensure that such a manipulator can perform tasks with a specified level of accuracy, which is desired to be maintained. Manual calibration and/or calibration carried out in a pre-specified calibration area are known to enable accurate operation; however, they come at a significant cost. These options require additional personnel, equipment, and time. Hence, they are costlier overall, and decrease the flexibility of the robotic systems.

Further, most calibration parameters may change over a robot's lifetime. Such change, as an example, may be due to general wear and tear. Therefore, calibration at periodic intervals is required to perform tasks with a desired level of accuracy. One way to efficiently compensate for these changes is to employ self-calibration techniques, in which the robot manipulator calibrates independently using only its on-board hardware.

Reliable self-calibration has already been demonstrated for certain sensor combinations, including lidars, cameras and inertial measurement units. Refer, Nicholas Roy and Sebastian Thrun, “Online Self-Calibration for Mobile Robots,” in Proc. IEEE Int. Conf. Robotics and Automation, 1998; J. Kelly, et al, “Visual-Inertial Sensor Fusion: Localization, Mapping and Sensor-to-Sensor Self-Calibration,” Int. J. Rob. Res., vol. 30, no. 1, pp. 56-79, 2011; M. Sheehan, et al, “Self-Calibration for a 3D Laser,” Int. J. Rob. Res., vol. 31, no. 5, pp. 675-687, 2011; and J. Lambert, et al, “Entropy-Based Sim(3) Calibration of 2D lidars to Egomotion Sensors,” in Proc. IEEE Int. Conf. Multisensor Fusion and Integration for Intelligent Systems, 2016, pp. 455-461.

Despite the success of self-calibration for sensing applications, there has been relatively little work on combined sensor-actuator self-calibration for mobile platforms. While classical manipulator intrinsic calibration, or kinematic model calibration, has a long history in industrial environments, as disclosed by B. W. Mooring, Z. S. Roth, et al, in “Fundamentals of Manipulator Calibration,” Wiley-Interscience, 1991, all these methods require specialized external measurement devices and trained human operators.

Similarly, much of the work on sensor (e.g., camera) extrinsic calibration relative to an arm's end-effector typically makes use of external fiducial markers, as disclosed by V. Pradeep, et al, in “Calibrating a Multi-arm Multi-Sensor Robot: A Bundle Adjustment Approach,” in International Symposium on Experimental Robotics (ISER), New Delhi, India, 2010. Alternatively, specialized hardware attachments are made use of, as disclosed by P. Pastor, et al, in “Learning Task Error Models for Manipulation,” in Proc. IEEE Int. Conf Robotics and Automation, 2013, pp. 2612-2618. Further, use of specialized equipment is disclosed by J.-S. Hu, et al, in “Automatic Calibration of Hand-Eye-Workspace and Camera Using Hand-Mounted Line Laser,” IEEE/ASME Transactions on Mechatronics, vol. 18, no. 6, pp. 1778-1786, 2013. However, the use of supplementary equipment, often not readily available, makes these approaches less attractive than self-calibration.

Manipulator-camera extrinsic calibration has been well studied in the context of “eye-in-hand” systems (with the camera attached the end-effector), and for fixed external cameras. For both configurations, majority of calibration techniques make use of fiducial markers to facilitate end-effector localization as disclosed by S. Kahn, et al, in “Hand-eye Calibration with a Depth Camera: 2D or 3D?” Proc. IEEE Int. Conf. Computer Vision Theory and Applications (VISAPP), 2014, vol. 3, 2014, pp. 481-489; and O. Birbach, et al, in “Rapid calibration of a multi-sensorial humanoids upper body: An automatic and self-contained approach,” Int. J. Rob. Res., vol. 34, no. 4-5, pp. 420-436, 2015. In the “eye-in-hand” case, the manipulator's EE motion can be coupled with the camera's motion, allowing for the use of structure from motion techniques to recover the transform, as disclosed by J. Heller, et al, in “Structure-from-motion based hand-eye calibration using L. minimization,” Proc. IEEE Conf Computer Vision and Pattern Recognition, 2011, pp. 3497-3503; and J. Schmidt, et al, in “Calibration-Free Hand-Eye Calibration: A Structure-from-Motion Approach,” Joint Pattern Recognition Symposium, Springer, 2005, pp. 67-74. Unfortunately, these methods do not apply to a fixed camera.

O. Birbach, et al, in “Rapid calibration of a multi-sensorial humanoids upper body: an automatic and self-contained approach,” Int. J. Rob. Res., vol. 34, no. 4-5, pp. 420-436, 2015, disclose determining the transform of a fixed camera using built-in fiducial markers on the end-effector. However, the drawback is that the end-effector needs to remain in the field of view of the camera at all times.

Moving on to manipulator kinematic model calibration, generally high-accuracy external measurement devices are used to track the end-effector, providing up to sub-millimetre accuracy in some cases, as disclosed by A. Nubiola, et al, in “Absolute robot calibration with a single telescoping ballbar,” Precision Engineering, vol. 38, no. 3, pp. 472-480, 2014; and M. Gaudreault, et al, in “Local and Closed-Loop Calibration of an Industrial Serial Robot using a New Low-Cost 3D Measuring Device,” Proc. IEEE Int. Conf. Robotics and Automation, 2016, pp. 4312-4319. However, such high accuracy may not be essential in collaborative, person-safe platforms, where target tasks are typically grasping of objects. Further, being able to calibrate automatically and without additional equipment has several advantages.

The use of contact in the context of perception, motion planning and manipulation has been explored in the past. K. T. Yu, et al, in “Shape and Pose Recovery from Planar Pushing,” Proc. IEEE/RSJ Int. Conf Intelligent Robots and Systems, 2015, pp. 1208-1215, have exploited the local but detailed nature of contact measurements in order to recover the shape and pose of a movable planar object, drawing inspiration from Simultaneous Localization and Mapping (SLAM) techniques. Similarly, contact has been combined with vision to provide a multi-modal strategy for tracking objects, as disclosed by G. Izatt, et al, in “Tracking Objects with Point Clouds from Vision and Touch,” Proc. IEEE Int. Conf Robotics and Automation, 2017, pp. 4000-4007; and M. C. Koval, et al, in “Pose Estimation for Contact Manipulation with Manifold Particle Filters,” Proc. IEEE/RSJ Int. Conf Intelligent Robots and Systems, 2013, pp. 4541-4548. In these works, contact plays a complementary role to vision by providing information at the time of grasping, when the robot's manipulator is most likely to occlude the object. A. Roncone, et al, in “Automatic kinematic chain calibration using artificial skin: self-touch in the iCub humanoid robot,” Proc. IEEE Int. Conf Robotics and Automation, 2014, pp. 2305-2312, employ tactile skin on a humanoid robot's head to calibrate the arm kinematic chain.

Further, the accuracy, convergence and observability of point cloud registration has been well studied in both robotics and graphics, as disclosed by P. J. Besl, et al, in “A Method for Registration of 3-D Shapes,” IEEE Trans. Pattern Analysis and Machine Intelligence, vol. 14, no. 2, pp. 239-256, 1992; and Y. Chen, et al, in “Object Modeling by Registration of Multiple Range Images,” Proc. IEEE Int. Conf. Robotics and Automation, 1991, pp. 2724-2729. The derivations of the observability of both the point-to-point and point-to-plane cost functions are presented and shown to be related to the eigenvalues and eigenvectors of the Hessian matrix of the cost function by A. Censi, in “An Accurate Closed-Form Estimate of ICP's Covariance,” Proc. IEEE Int. Conf Robotics and Automation, 2007, pp. 3167-3172; and S. Bonnabel, et al, in “On the Covariance of ICP-Based Scan-Matching Techniques,” 2014. arXiv: 1410.7632 [cs.CV]. Similarly, a study of the observability of registration given common surface types is carried out, and the respective unconstrained or unobservable directions of surface motion are identified by N. Gelfand, et al, in “Geometrically Stable Sampling for the ICP Algorithm,” Proc. Int. Conf 3-D Digital Imaging and Modeling, 2003, pp. 260-267; and S. Rusinkiewicz, et al, in “Efficient Variants of the ICP Algorithm,” Proc. Int. Conf. 3-D Digital Imaging and Modeling, 2001, pp. 145-152. The quality of registration is shown to be related to the choice of points used and a stable sampling strategy is detailed. Non-rigid ICP is used to more accurately align two 3D scans by considering camera calibration errors as non-rigid deformations by B. J. Brown, et al, in “Global Non-Rigid Alignment of 3-D Scans,” ACM SIGGRAPH 2007 Papers, ser. SIGGRAPH '07, New York, N.Y., USA: ACM, 2007.

In view of the foregoing, there is a need for improved technique that enable automatic, in-situ calibration of a manipulator end-effector to an externally-mounted depth sensor, without the use of additional hardware.

### SUMMARY OF THE INVENTION

In one embodiment of the invention, there is disclosed a method of calibrating a manipulator and an external sensor, the method including the steps of generating a first point cloud map using depth information, generating a second point cloud map using contact information, and recovering extrinsic parameters by aligning the first map and the second map.

In an aspect of the invention, generating the first point cloud map includes collecting the depth information using a depth sensor.

In another aspect of the invention, the depth sensor is stationary relative to a base frame of the mobile manipulator.

In another aspect of the invention, collecting the depth information includes collecting the depth information corresponding to a rigid structure.

In another aspect of the invention, generating the second point cloud map includes collecting the contact information by moving an end effector of the (mobile) manipulator over the rigid structure.

In another aspect of the invention, the depth information is collected from a single or from a plurality of vantage points.

In another aspect of the invention, aligning the first cloud map and the second cloud map includes applying the iterative closest point algorithm.

In another aspect of the invention, recovering the extrinsic parameters further includes accounting for kinematic model biases of the (mobile) manipulator.

Various other embodiments and aspect of the invention will be readily understood by one skilled in the art having regards to the detailed description below.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 illustrates a mobile robot manipulator 100 and relevant frames, in accordance with an embodiment;

FIG. 2 illustrates two point clouds 204, 206 derived from a depth sensor 104 and contact sensor of an end effector 106 to simultaneously calibrate the depth sensor extrinsic parameters and manipulator kinematic parameters using non-rigid point cloud alignment;

FIG. 3A illustrates a front view, and FIG. 3B illustrates a side view of an example end effector contact point, in which visualization of the location of the contact point at the end effector tip is overlaid as a cross;

FIGS. 4A, 4C and 4E illustrate actual point cloud in isometric, top and front views, respectively.

FIGS. 4A, 4C and 4E illustrate a biased point cloud in isometric, top and front views, respectively, wherein the illustrations are an example of the deformation of a contact-based point cloud when a single joint bias of 0.5 radians is added to one joint; although 0.5 radians is not likely to be a realistic bias amount, the quantity is used to demonstrate the clear effects on a contact-based point cloud given model errors;

FIG. 5 illustrates a robot used for collecting point clouds, including manipulator mounted on a mobile base, an RGB-D sensor, and a force-torque sensor attached at the wrist of the manipulator;

FIG. 6A illustrates an actual calibration surface, in accordance with an embodiment;

FIG. 6B illustrates a depth camera point cloud map of the calibration surface of FIG. 6A;

FIG. 6C illustrates a sparse contact point cloud map of the calibration surface of FIG. 6A;

FIG. 7 illustrates five ARTag positions used in an example task-based validation procedure, wherein an attempt is made to use poses with enough variety in location and orientation in order to eliminate the possibility that there is systematic bias in the extrinsic calibration estimate;

FIG. 8 illustrates force registered on the gripper, and relative height change, between F_{E} and F_{R}, measured while collecting several hundred points from a flat, horizontal surface; notable the gripper moved approximately 10 cm across the surface; maintaining stable control given noisy force-torque measurements is difficult, as shown in the top plot; the impedance controller is able to maintain a total force on the gripper of less than 10 N; despite the force change, the relative change in end effector height never exceeds 1 mm in both plots;

FIG. 9A illustrates contact map in white after an initial transform guess is applied;

FIG. 9B illustrates contact map and KINECT map after final alignment;

FIG. 10 illustrate stability metric, c, defined in equation (19), for different surface contact maps, wherein planes which are not sampled from are in red and the lighter red represents down-sampling to 500 contact points from the original 65000 contact points; and

FIG. 11 illustrate errors in end effector position after the calibration procedure, wherein in this specific example, the error is the difference between the desired position of F_{E} relative to the ARTag and the ground truth position as measured by VICON.

### DETAILED DESCRIPTION

The present disclosure relates to a method of automatic, in-situ calibration of a (an optionally mobile) manipulator end-effector to an externally-mounted depth sensor, using only the on-board hardware.

The following description illustrates principles, which may be applied in various ways to provide many different alternative embodiments. This description is not meant to limit the inventive concepts in the appended claims. The principles, structures, elements, techniques, and methods disclosed herein may be adapted for use in other situations where calibration of relative position and orientation of a sensor mounted on a system to an end-effector of the mobile system is desired, wherein the position of the sensor is unaffected by the movement of the end-effector. The system may be mobile or stationary.

While exemplary embodiments of the present technology have been shown and described in detail below, it will be clear to the person skilled in the art that changes, and modifications may be made without departing from its scope. As such, that which is set forth in the following description and accompanying drawings is offered by way of illustration only and not as a limitation. In addition, one of ordinary skill in the art will appreciate upon reading and understanding this disclosure that other variations for the technology described herein can be included within the scope of the present technology. The following detailed description includes references to the accompanying drawings, which form part of the detailed description. The drawings show illustrations in accordance with example embodiments. These example embodiments are described in enough details to enable those skilled in the art to practice the present subject matter. However, it may be apparent to one with ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized, or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a non-exclusive “or”, such that “A or B” includes “A but not B”, “B but not A”, and “A and B”, unless otherwise indicated.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and do not limit the scope of the claims.

A variety of exemplary embodiments will be disclosed herein. The features illustrated or described in connection with one exemplary embodiment may be combined with the features of other embodiments. Such modifications and variations are intended to be included within the scope of the present application.

In many cases, the methods and systems disclosed herein can be implemented using, amongst other things, software created as directed by the teachings herein and in accordance with an object oriented programming scheme. Principles of object-oriented programming and programming languages, (e.g., C++) are known in the art.

In an embodiment, a method is provided for automatic self-calibration of relative position and orientation of an external sensor mounted on a (mobile) robot manipulator to the base and end-effector of the robot manipulator.

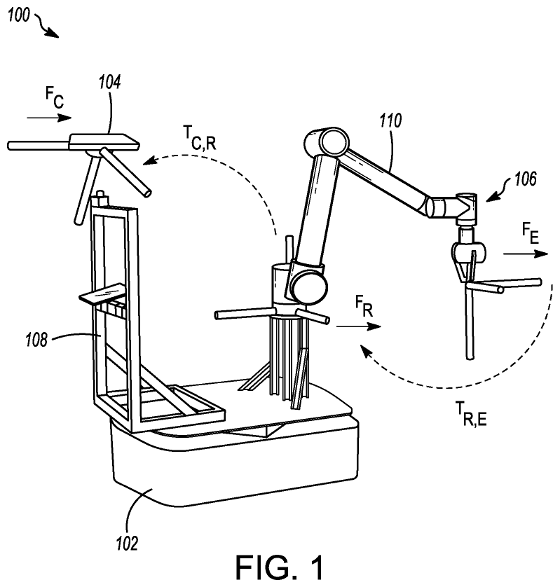

Referring to the figures, and more specifically to FIG. 1, a robot manipulator 100 is disclosed. The robot manipulator 100 includes a mobile platform 102, depth sensor 104 and an end effector 106. The depth sensor 104 is mounted on a sensor mast 108, whereas the end effector 106 is connected to a manipulator arm 110. The motion of the manipulator arm 110 does not affect the position of the depth sensor 104. In that sense, the depth sensor 104 is external to the manipulator arm 110. In other words, the position of the depth sensor 104 is independent of the position of the manipulator arm 110, and thereby the end effector 106. However, notably the depth sensor 104 is not external to the robot manipulator 100 itself and may be considered stationary relative to the mobile platform 102. The depth sensor 102, which is capable of providing depth information, may be a vision sensor, example of which includes a RGB-D camera. The end effector 104 may include a force-torque sensor. Robot manipulator 100 may be mobile or may be stationary. Any references in this description to mobile manipulator will be understood to be equally applicable to a stationary manipulator, unless explicitly noted otherwise.

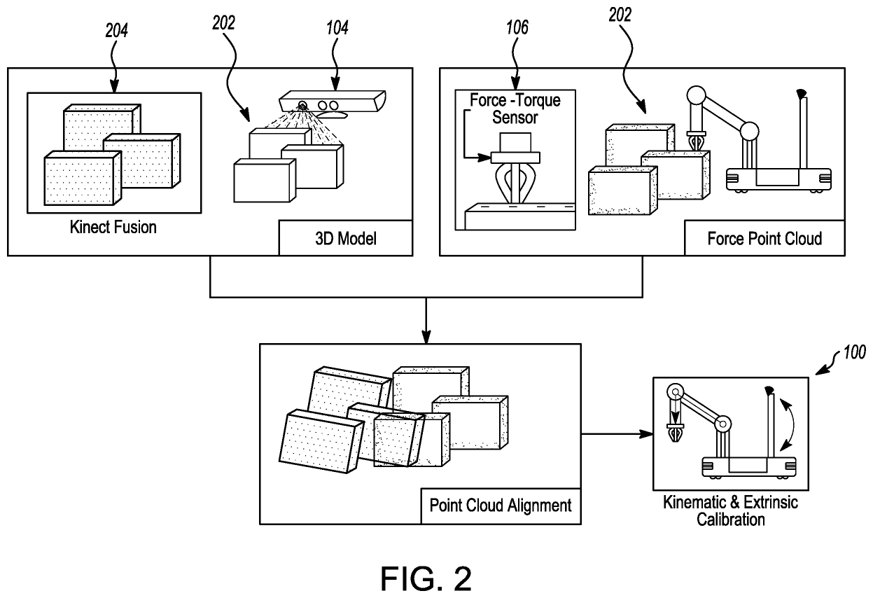

Now referring to FIG. 2 as well, the method of calibration includes determining the extrinsic transform between the end effector 106 and the depth sensor 104. In this method, the structure 202 of the immediate environment (surfaces) is leveraged for calibration. Data obtained from the depth sensor 104 is used to generate a first point cloud map 204, which may be referred to as fused point cloud map 104. The data to generate the fused point cloud map 104 is obtained by moving the mobile base 102 to multiple vantage points and capturing depth information corresponding to the structure 202 using the depth sensor 104. Further, a second point cloud map 206 is generated using data obtained from the force-torque sensor at the end effector 106. The second point cloud map 206 may be referred to as contact or force point cloud map 206. The contact point cloud map 206 is generated by maintaining a fixed force profile (using the force-torque sensor at the end effector 106) while moving over the rigid surfaces of the structure 202. The fused point cloud map 204 is then aligned with the contact point cloud map 206 using the Iterative Closest Point (ICP) algorithm to recover extrinsic parameters. In addition, kinematic model parameters can be introduced into the foregoing procedure.

### Extrinsic Calibration Using Depth And Contact

In an embodiment, the method of calibration includes a formulation of the problem in which calibration of the extrinsic transform is considered without kinematic model bias parameters. Referring to FIG. 1 again, F_{C} is the optical frame of the depth sensor 104, F_{R} is the manipulator's base frame, and F_{E} is the tip of the end effector 106, where contact with a surface is made. Transform T_{R,E} is given by the arm forward kinematics, while transform T_{C,R} is the extrinsic transform that is solved for.

In the instant approach, transform T_{C,R}∈SE(3) is solved for, between the manipulator's base frame F_{R} and the depth sensor's 104 frame F_{C}. The set of constant transform parameters is:

Ξ=[xₑyₑzₑϕₑθₑψₑ]^{T}, (1)

where Ξ is a vector of the three translation and three rotation parameters. Assumption is made as to availability of access to an intrinsically calibrated depth sensor 104 capable of generating a 3D point cloud map and that contact within the end effector's 106 frame can be detected and estimated as a 3D point measurement. That is, the 6 degree of freedom (DOF) frame F_{E} is placed at a location on the gripper which can easily be isolated and estimated as a point of contact. A further assumption is made that the surfaces touched by the end effector 106 are rigid and that there is negligible deformation during contact.

The depth sensor 104 provides a point cloud map B in F_{C} and the contact or force-torque sensor gives a second point cloud map A in F_{R},

A={a₁,a₂, . . . ,aₙ},B={b₁,b₂, . . . ,bₙ}, (2)

where a₁ and b₁ are the 3D coordinates of points in the two clouds 204, 206, and a₁ are the points in A in homogeneous form. An important aspect to consider is that F_{E} is a moving frame which follows the end effector's 106 motion. In order to generate a consistent contact point cloud map 206, points in A all need to be represented in a fixed frame. The manipulator's base frame F_{R} is chosen as the fixed frame. The transform T_{R,E} between the manipulator's base frame and the end effector 106 is assumed to be known from the corresponding joint encoder readings θᵢ=[θ_{1,i}, θ_{2,i}, . . . , θ_{6,i}] for each contact point aᵢ and a kinematic model,

aᵢ=T_{B,E}(θᵢ,Ψ)[0001]^{T}. (3)

The Denavit-Hartenberg (DH) parametrization for forward kinematics is used,

T_{B,E}(θᵢ,Ψ)=D_{0,1}(θ_{1,i},ψ₁) . . . d_{k-1,k}(θ_{k,i},ψₖ) . . . D_{K-1,K}(θ_{K,i},ψ_{K}). (4)

where each D_{k-1,k} is the respective DH matrix from manipulator joint frame k−1 to k with parameters ψₖ=[aₖrₖdₖ], given as:

$${D}_{k - 1 , k} = [ \begin{matrix}cos {θ}_{k} & - sin {θ}_{k} cos {α}_{k} & sin {θ}_{k} sin {α}_{k} & {r}_{k} cos {θ}_{k} \\ sin {θ}_{k} & cos {θ}_{k} cos {α}_{k} & - cos {θ}_{k} sin {α}_{k} & {r}_{k} sin {θ}_{k} \\ 0 & sin {α}_{k} & cos {α}_{k} & {d}_{k} \\ 0 & 0 & 0 & 1\end{matrix} ] . \qquad ( 5 )$$

The transform between the depth sensor 104 and end effector 106 can then be represented as:

T_{C,E}(Ξ,θᵢ,Ψ)=T_{C,B}(Ξ)T_{B,E}(θᵢ,Ψ), (6)

### Rigid ICP

ICP algorithm is used to align the two point clouds 204, 206, alternating between a data association step and an alignment error minimization step, based on the transform parameters. An example point-to-plane error metric is disclosed by Y. Chen and G. Medioni, in “Object Modeling by Registration of Multiple Range Images,” Proc. IEEE Int. Conf. Robotics and Automation, 1991, pp. 2724-2729, which is used in order to best leverage the surface information contained in the dense fused point cloud map 204. The error function to be minimized is, explicitly,

$${J}_{pn} ( Ξ ) = {\sum }_{i} {w}_{i} {‖ {n}_{i}^{T} ( {PT}_{C . B} ( Ξ ) {a}_{i} - {b}_{i} ) ‖}^{2} . \qquad ( 7 )$$

where T_{C,B} is the rigid transform which is solved for, aᵢ are the contact points as defined in equation (3), wᵢ are the weighing factors for outlier removal, and bᵢ are the depth sensor points with their respective surface normals nᵢ, and wᵢ are weights used for outlier removal. The matrix P is

P=[I₃0_{3×1}] (8)

where I₃ is the 3×3 identity matrix. The point-to-plane metric constrains the direction of motion to the direction perpendicular to the local plane. From a practical design point of view, given that an idealized point estimate of the end effector's flat tip is used, the point-to-plane metric does not weight the uncertain planar direction of the EE's contact point.

### Shape, Contact, and Observability

In the case of extrinsic calibration, the shape of the environment and the choice of which contact points to collect directly affect the accuracy and convergence of the solution. As shown by S. Rusinkiewicz and M. Levoy, in “Efficient Variants of the ICP Algorithm,” Proc. Int. Conf. on 3-D Digital Imaging and Modeling, 2001, pp. 145-152; and N. Gelfand, L. Ikemoto, S. Rusinkiewicz, and M. Levoy, “Geometrically Stable Sampling for the ICP Algorithm,” Proc. Int. Conf 3-D Digital Imaging and Modeling, 2003, pp. 260-267, different surface shapes may result in unconstrained or unobservable directions of motion during point cloud registration; depending on how points are sampled, more or less accurate convergence is achieved. Further, N. Gelfand, et al, in “Geometrically Stable Sampling for the ICP Algorithm,” Proc. Int. Conf 3-D Digital Imaging and Modeling, 2003, pp. 260-267, demonstrate that points sampled from three planar orthogonal surfaces are sufficient to constrain a rigid transform. A summary of more surface types and their unconstrained directions is disclosed by N. Gelfand, et al.

Based on the point-to-plane cost function, a principled measure of the stability of the solution is obtained based on the sampled contact points A, relative to the surface points in B, by examining the eigenvalues of the approximate Hessian of the cost function, as disclosed by S. Rusinkiewicz and M. Levoy. Given (7), the rotation is linearized and the cost function reformulated as a sum of squares as done by A. Censi, in “An Accurate Closed-Form Estimate of ICP's Covariance,” Proc. IEEE Int. Conf. Robotics and Automation, 2007, pp. 3167-3172; and S. Bonnabel, M. Barczyk, and F. Goulette, “On the covariance of ICP-based scan-matching techniques,” 2014. arXiv: 1410.7632 [cs.CV]:

$${\overline{J}}_{pn} ( ΔΞ ) = {\sum }_{i} {w}_{i} {\vert {r}_{i} - {J}_{i} ΔΞ \vert}^{2} . \qquad ( 9 )$$

where ΔΞ is an incremental (small angle) update to the cur-rent transform parameters, Ξ. The residuals ri and Jacobian matrices Ji are, respectively,

rᵢ=nᵢ^{T}(PT_{C,B}(Ξ)aᵢ−bᵢ), (10)

and

Jᵢ=[−nᵢ^{T}−(aᵢ^{x}nᵢ)^{T}], (11)

where a^{x}ᵢ represents the skew-symmetric matrix form of aᵢ. In the vicinity of the true minimum, Ξ=\hat{ }Ξ, solving Eq. (9) for the incremental update yields the following quadratic form,

ΔJₚₙ(ΔΞ)=ΔΞ^{T}QΔΞ, (12)

where ΔJₚₙ=Jₚₙ(Ξ)−Jₚₙ(Ξ), ΔΞ=Ξ−Ξ and Q=ΣᵢJᵢ^{T}Jᵢ.

Eq. (12) measures how the cost changes as Ξ moves away from the minimum \hat{ }Ξ. If a change in ΔΞ results in little (no) change in ΔJₚₙ, then the solution is underconstrained in that direction. Further, a small eigenvalue of the approximate Hessian Q identifies an unobservable motion in the direction of the associated eigenvector. Thus, we choose our measure of stability or observability to be based on the condition number c of the matrix Q,

With the eigenvalues of Q, λ₁>λ₂> . . . . >λ₆, the stability metric is then:

$$c = \frac{{λ}_{1}}{{λ}_{6}} \qquad ( 13 )$$

As c approaches 1, the motion of point cloud A relative to B becomes increasingly more constrained. Similarly, small eigenvalues represent unconstrained or unobservable relative motions, in the direction of the respective eigenvector, between the two surfaces being registered.

### Manipulator Kinematic Model Bias Calibration Through Non-Rigid ICP

Rigid ICP is used to solve for a 6-DOF rigid-body transform. In order to account for kinematic model biases (e.g., joint angle biases), equation (8) must be modified to incorporate more than the six rigid transform parameters. A possible mathematical formulation of this modification is provided below.

The transform T of cost function (8) is modified to be non-rigid. Instead of solving only for T_{C,R} using the ICP algorithm only, inventors solve for T_{C,R}, as defined in equation (7), but with the added DH parameter biases incorporated in the forward kinematics transform T_{R,E}. To simplify the problem, instead of solving for all DH parameter errors, inventors give the example of solving for joint angle biases only (δθ):

àᵢ=T_{B,E}(θᵢ+δθ,Ψ)[0001]^{T}, (14)

The new cost function is:

$${\tilde{J}}_{pn} ( Ξ . δθ ) = {\sum }_{i} {w}_{i} {‖ {n}_{i}^{T} ( {PT}_{C . B} ( Ξ ) {\tilde{a}}_{i} - {b}_{i} ) ‖}^{2} . \qquad ( 15 )$$

where \tilde{ }aᵢ is the homogeneous form of a\hat{ }ᵢ. Therefore, J\hat{ }ₚₙ is a function of 6+K parameters: six parameters that define the extrinsic transform, Ξ, and an additional K that form the set δθ of joint angle biases for a K-DOF (rotary joint) manipulator. To determine Ξ and δθ, we use a standard nonlinear least squares solver (i.e., Levenberg-Marquardt).

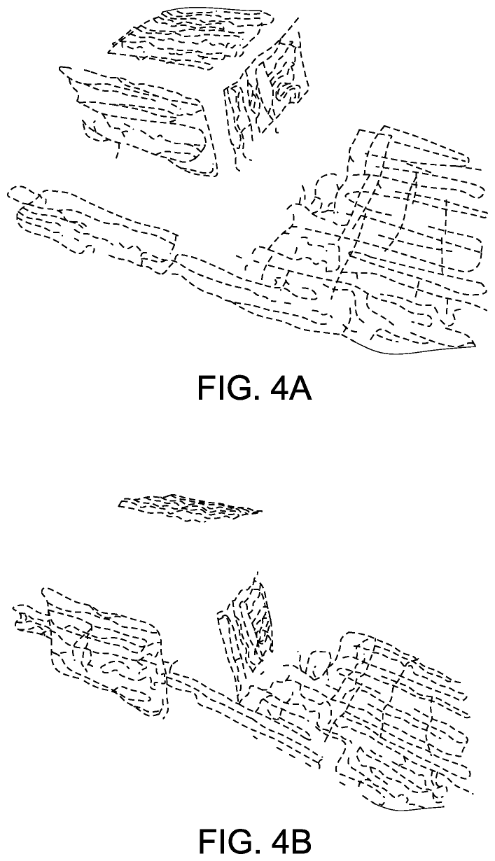

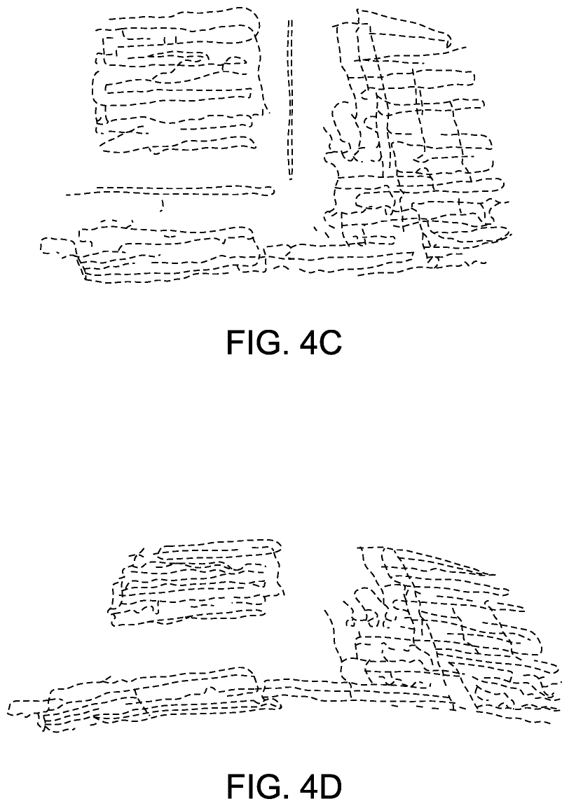

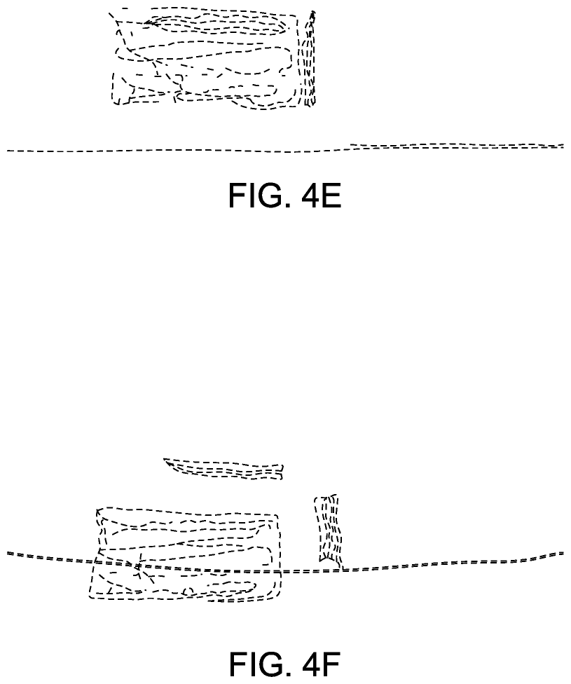

In practice, there may be more or less than six joint angle biases, depending on the how many rotary joints are in the manipulator. The transform is no longer rigid, and each point in the contact point cloud will move as δθ is modified at each iteration. The effects on a contact point cloud collected with one biased joint angle value are shown in FIGS. 4A to 4F.

### Experiments And Results

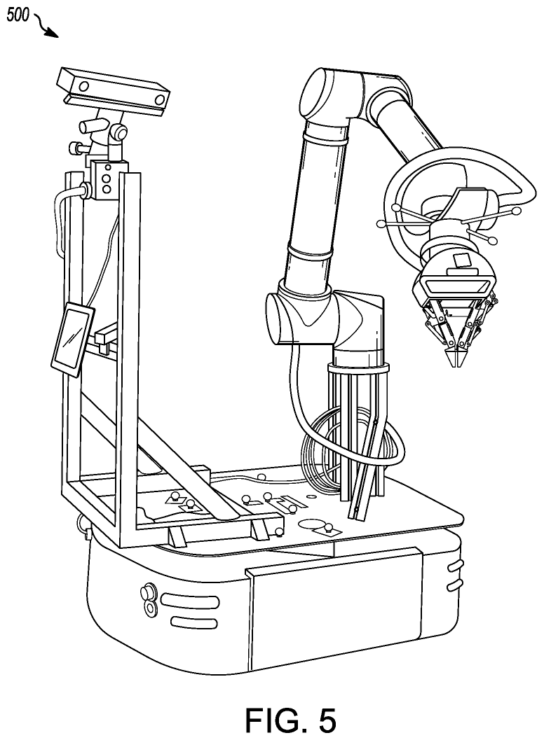

To validate the extrinsic calibration method, inventors performed multiple tests using a mobile manipulator 500 as shown in FIG. 5. A KINECT V2 RGB-D sensor is mounted on the sensor mast of the mobile base. The gripper has a Force Torque (F/T) sensor attached to it which is used in concert with an impedance controller. The controller maintains contact between the end effector and the surface while creating the contact point cloud 206. For the experiments reported here, focus is on extrinsic calibration only.

After collecting three RGB-D point clouds 204 and three corresponding contact point clouds 206, inventors determined the extrinsic calibration between the arm end effector frame and the RGB-D frame by registering the two point clouds 204, 206. Finally, extrinsic calibration results are validated by performing an accuracy test, where the robot end effector is commanded to reach a position given in the RGB-D frame. These experiments, as well as the results, are described in greater detail below.

### Object Selection for Point Clouds

Inventors demonstrated the self-calibration approach using two simple rectangular boxes (prisms). This particular shape is selected based on the following criteria:

1) it is representative of readily available shapes in most environments,

2) its shape is mappable to a high fidelity with most contact or tactile sensors,

3) the surfaces of a rectangular prism fully constrain the ICP-based alignment.

Item one and two are practical requirements based on the resolution and type of contact or tactile sensor used. As contact and tactile sensors become more accurate and capable of higher resolution measurements, these requirements will be relaxed and more arbitrary and complex shapes will become more easily mappable.

### RGB-D Point Cloud Acquisition

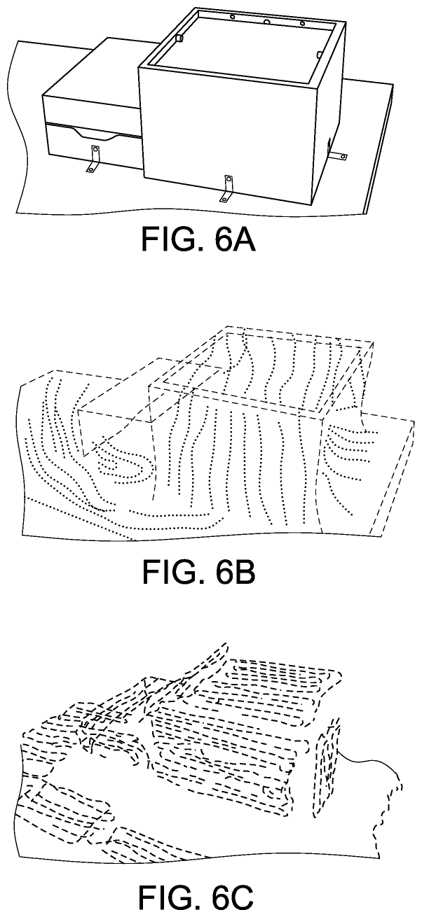

Inventors gathered a point cloud map of the environment using KINECTFUSION, as disclosed by R. A. Newcombe, S. Izadi, O. Hilliges, D. Molyneaux, D. Kim, A. J. Davison, P. Kohi, J. Shotton, S. Hodges, and A. Fitzgibbon, in “KinectFusion: Real-Time Dense Surface Mapping and Tracking,” Proc. IEEE Int. Symp. Mixed and Augmented Reality, 2011, pp. 127-136, taking advantage of the holonomic mobile base to generate a fused map 204 from multiple viewpoints. One of the point clouds used in the experiments is shown in FIG. 6B. After collecting the KINECT point cloud, the mobile base is kept fixed in its final position for the contact mapping phase. Since KINECTFUSION is no longer running, any base movement is not compensated for in the final estimate of the transform between both maps. The approach relies heavily on the accuracy of KINECTFUSION's mapping results. It is likely that some of the error introduced into the calibration is due to artifacts in the point cloud map introduced by the KINECTFUSION algorithm itself. Notably, KINECTFUSION struggles to map sharp edges and introduced a ‘bow’ in flat walls, as shown on the right side of FIG. 6B.

### Contact Point Cloud Acquisition

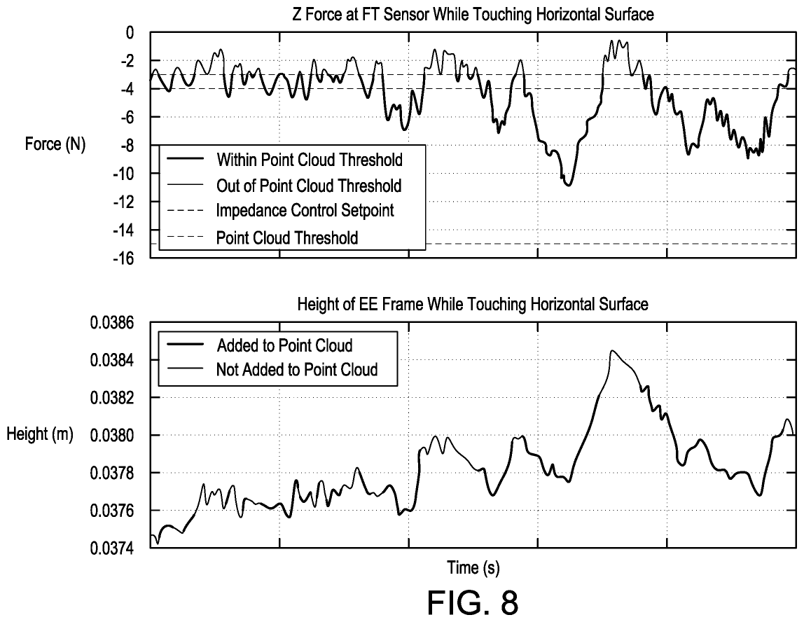

To collect points for the contact cloud 206, a semi-automated procedure is used in which the user selected the x and y coordinates of the end effector (in the end effector frame), while the z position of the end effector (gripper) was controlled via a PID loop to maintain light surface contact. An example of the force readings and the resulting changes in height, the perpendicular distance from a particular surface, of the end effector are shown in FIG. 8. The recommended threshold for contact sensing, supplied by the manufacturer of the FT sensor, is 2 N, and the rated standard deviation of the sensor noise is 0.5 N, although it was found to be closer to 1 N in experiments. This procedure could easily be fully automated.

The z-direction force reading was used as a threshold for selecting points to add to the contact cloud. For experiments, set the ‘minimum’ force threshold to −3 N (i.e., against the gripper) and the ‘maximum’ force threshold to −15 N. The thresholds were chosen to ensure that points are only collected when there was sufficient contact and also a low risk of object deformation. The set point for the impedance controller was −4 N. Although intuition would suggest using an impedance value exactly in between the threshold values, the impedance set point was reduced to make certain that the surface was not damaged or altered by contact.

One of the contact point clouds is shown in FIG. 6C. As expected from the very minimal height changes shown in FIG. 8, all surfaces that should be flat do in fact appear flat in the contact cloud. Likewise, surfaces that should be perpendicular to one another also appear to be so. As an additional validation step, inventors compared the measured (34.93 cm) and known value (34.5 cm) of the distance between two surfaces on one of the cubes.

### Point Cloud Registration Procedure

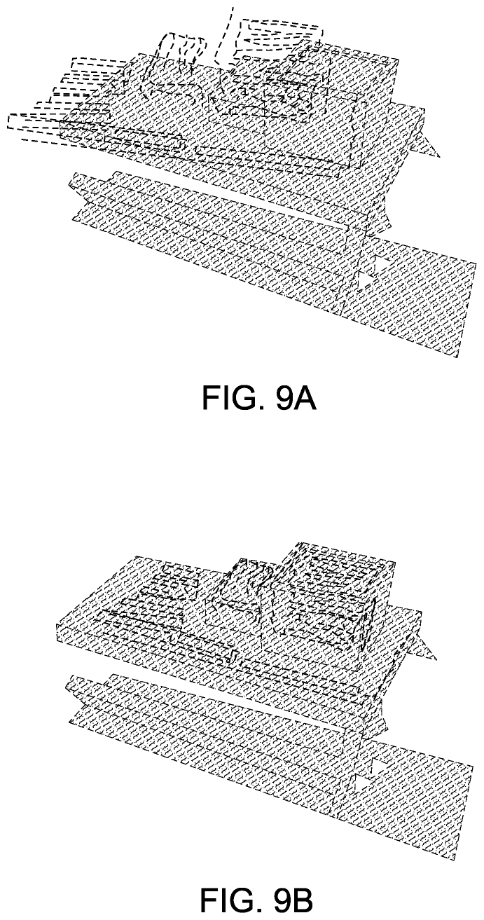

Inventors made use of the ICP implementation available in libpointmatcher, as disclosed by F. Pomerleau, F. Colas, and R. Siegwart, in “A Review of Point Cloud Registration Algorithms for Mobile Robotics,” Foundations and Trends in Robotics, vol. 4, no. 1, pp. 1-104, 2015, for rigid registration. An initial guess for the transform parameters is required; inventors determined this through rough hand measurement of the position and orientation of the KINECT relative to the manipulator base. An example of the initial and final alignment of the point clouds is shown in FIGS. 9A and 9B, respectively. The final calibration results are given in Table I. The results are the average of three separate trials, each with a different contact map (collected by the robot), to ensure that a specific contact map did not bias the results. Trial I was carried out with both prisms in the environment, while Trials II and III were performed by sampling from a single prism only.

TABLE I
Extrinsic calibration results of the three separate trials.

| | Extrinsic Calibration Results | | | | | |
|---|---|---|---|---|---|---|
| | x[mm] | y[mm] | z[mm] | ϕ[deg] | θ[deg] | ψ[deg] |
| Initial Guess | 800 | 300 | 600 | −125 | 0 | 0 |
| Trial 1 | 839.4 | 257.3 | 676.6 | −119.07 | 1.00 | 16.23 |
| Trial 2 | 834.6 | 259.0 | 691.6 | −120.18 | 1.27 | 15.62 |
| Trial 3 | 836.3 | 254.0 | 695 | −120.44 | 1.38 | 14.94 |
| μ (σ) | 836.77 (1.99) | 256.77 (2.08) | 687.73 (7.99) | −119.90 (0.59) | 1.22 (0.16) | 15.60 (0.53) |

### Task-Based Validation Results and Analysis

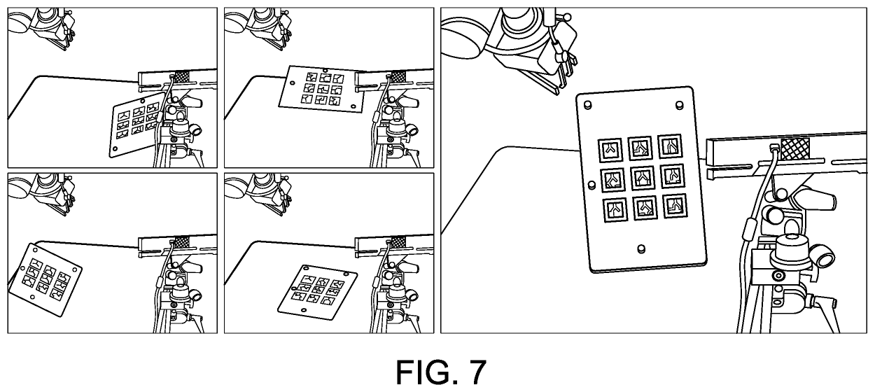

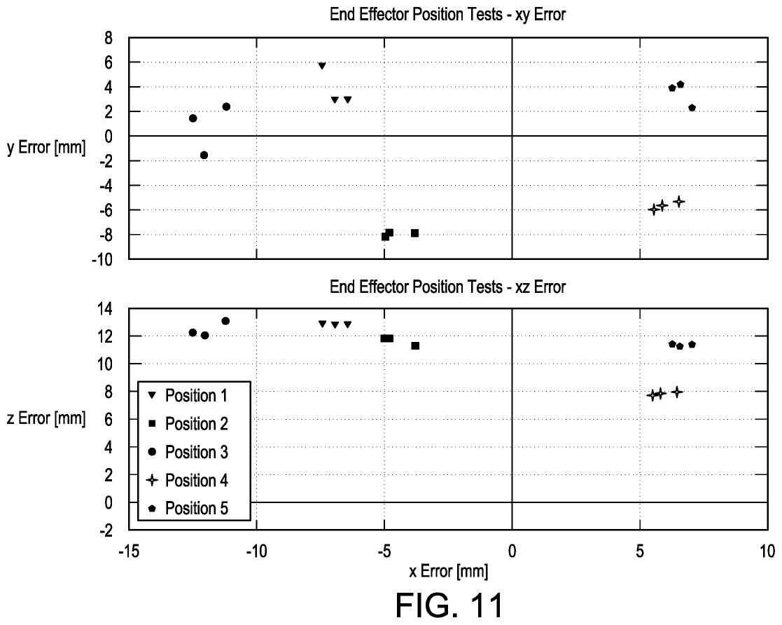

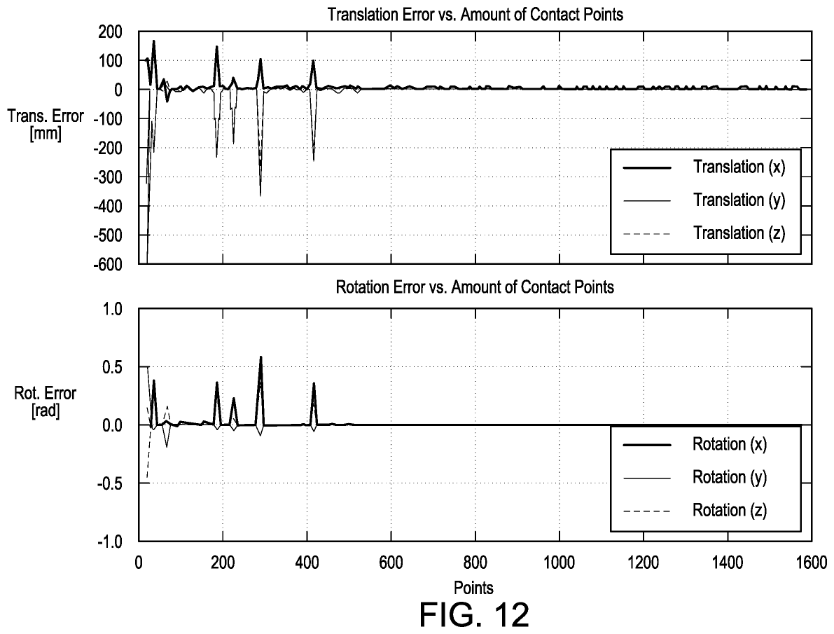

Inventors validated the estimate of the extrinsic calibration parameters with a task-based experiment using a VICON motion capture system and ARTags. Inventors placed a board with nine ARTags in five separate poses with significant translational and rotational variation, as shown in FIG. 7, that were both in view of the KINECT and in the workspace of the manipulator. In each of these poses, inventors commanded the arm (specifically F_{E} in FIG. 2) to go to a position with a specific offset from the center ARTag. Inventors recorded the translational error between the commanded positions and the ground truth positions using VICON. The results of this experiment are visualized in FIG. 11. Inventors also performed the same experiment with the extrinsic calibration initial guess shown in Table I, but in every case, the end effector missed the desired position by at least 25 cm.

The results in Table II show that the gripper position had a normalized average translational error of 13.97 mm. Inventors argue that for many standard manipulator tasks, such as pick and place, this amount of error would not prevent a task from being completed. As well, it appears that there is a systematic error in the z direction that could likely be improved with a better calibration between the KINECTFUSION frame and ARTag frame.

TABLE II
Position error for our task-based validation procedure.
Each plotted position is an average over three trials. The mean is
calculated as the average of the absolute error.

| | Position Error Results | | |
|---|---|---|---|
| | x[mm] | y[mm] | z[mm] |
| Position 1 | -6.91 | 3.66 | 12.66 |
| Position 2 | -4.51 | -8.04 | 11.64 |
| Position 3 | -11.93 | 0.73 | 12.40 |
| Position 4 | 6.01 | -5.81 | 7.76 |
| Position 5 | 6.73 | 3.38 | 11.28 |
| μ (absolute) | 7.22 | 4.33 | 11.15 |
| σ | 7.34 | 4.82 | 1.77 |

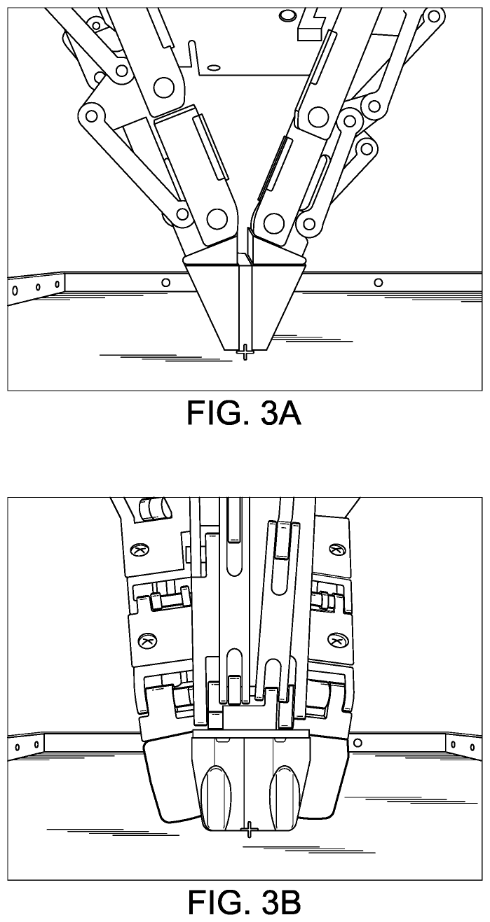

Although inventors did attempt to implement the non-rigid ICP solution proposed previously, with simulated joint angle biases on one of the datasets, inventors found that the resulting approximate Hessian from equation (13) had a very small determinant making the problem unsolvable for that specific dataset. Inventors suspect that the intuitive explanation was due to the lack of variety in joint configurations while collecting data, making it impossible to determine if a joint angle bias or an extrinsic camera error was causing the final error. In the future, this could be remedied by attempting to collect points with more variation in the arm configuration, as detailed by M. R. Driels and U. S. Pathre, “Significance of Observation Strategy on the Design of Robot Calibration Experiments,” J. Robot. Syst., vol. 7, no. 2, pp. 197-223, 1990, possibly by adding an attachment that would allow us to collect points while relaxing the constraint of F_{E} being perpendicular to the contact surface, as shown in FIGS. 3A and 3B.

### Effects of Surface Variation and Point Cloud Sparsification

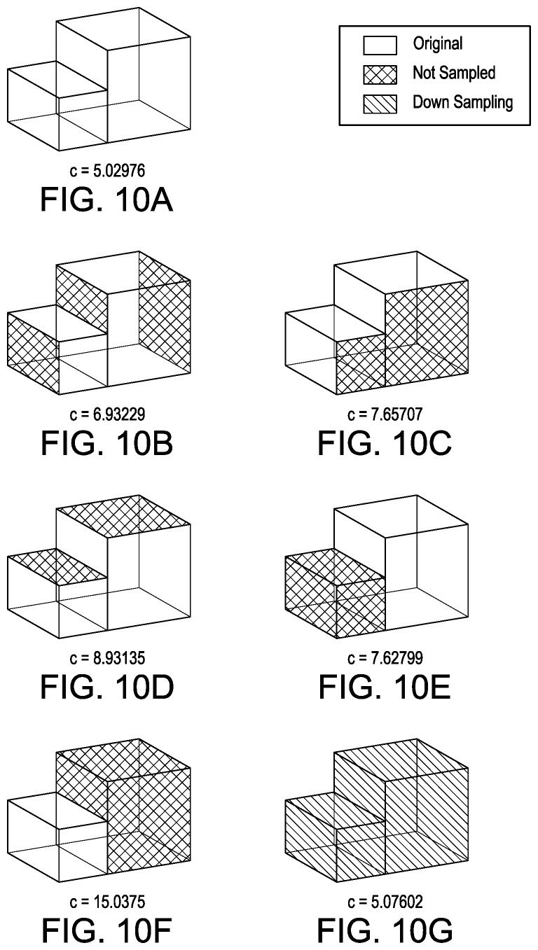

A study of the effects of varying the surfaces sampled to obtain the contact cloud, as well as the number of contact points collected during the calibration procedure was conducted. From a practical point of view, calibrating using simple shapes and fewer contact points potentially increases both the flexibility and speed of the process. FIG. 10 shows the stability metric (19), c, of the converged solution under different sampling scenarios. The choice of sampled surfaces is directly related to the stability of the converged solution, as one would expect.

The original contact point converged with a stability measure of c=5.02976, where a bigger c value implies a less stable convergence. First, the effect of not sampling certain planes was studied, shown in FIGS. 10 (b), (c) and (d) which increases the c value to 6.932, 7.657 and 8.931 respectively. Additionally, not sampling from either of the left or right prisms increased the c value to 7.628 and 15.037 respectively.

On the other hand, downsampling from 65,000 contact points to 500 contact points, as visualized in FIG. 10 (g), had a limited effect on the stability of the solution. Specifically, inventors downsampled by randomly selecting a certain number of points from the original cloud. This demonstrates that there were many redundant points in the original contact point cloud and a sparser cloud could have been used.

FIG. 12 demonstrates the effect of downsampling even further; as long as a minimum density and spread of points is maintained in the contact map, the procedure converges reliably and with stability. The key factor to consider to obtain a stable solution is the variety of surfaces sampled in the contact map. Note that these results hold for rigid registration-however, in the non-rigid case, increasing the number of sampled points is likely to improve the quality of the solution.

It shall be noted that the processes described above are described as sequence of steps; this was done solely for the sake of illustration. Accordingly, it is contemplated that some steps may be added, some steps may be omitted, the order of the steps may be re-arranged, or some steps may be performed simultaneously.

In view of the foregoing, one will appreciate the fact that an improved method is provided for performing extrinsic self-calibration between a manipulator and a fixed depth (or other type of) camera by leveraging contact as a previously unused sensor modality for this application. The method uses on-board sensors that are readily available on most standard manipulators and does not rely on any fiducial markers, or bulky and costly external measurement devices. Possible future work includes using sparse point cloud registration, as discussed by R. A. Srivatsan, P. Vagdargi, N. Zevallos, and H. Choset, in “Multimodal Registration Using Stereo Imaging and Contact Sensing,” to reduce the amount of contact points needed for convergence, implementing the non-rigid calibration for the DH kinematic parameters using a data set with more variety in manipulator configuration, as well as exploring the use of higher fidelity contact or tactile sensors allowing interaction with more complex shapes.

What is claimed is:

1. A method of calibrating a manipulator and external sensor, the method comprising:
generating a first cloud map using depth information;
generating a second cloud map using contact information; and
recovering extrinsic parameters by aligning the first cloud map and the second cloud map.

2. The method according to claim 1, wherein generating the first cloud map includes collecting the depth information.

3. The method according to claim 2, further comprising using one of a depth sensor or camera to collect the depth information.

4. The method according to claim 3, wherein the depth sensor is stationary relative to a base frame of the mobile manipulator.

5. The method according to claim 2, wherein collecting the depth information comprises collecting the depth information corresponding to a rigid structure.

6. The method according to claim 5, wherein generating the second cloud map comprises collecting the contact information by moving an end effector of the mobile manipulator over the rigid structure.

7. The method according to claim 5, wherein the depth information is collected from a plurality of vantage points.

8. The method according to claim 1, wherein aligning the first cloud map and the second cloud map comprises applying iterative closest point (ICP) algorithm.

9. The method according to claim 8, wherein recovering the extrinsic parameters further comprises accounting for kinematic model biases of the manipulator.

10. The method of claim 1, wherein the manipulator is mobile.

11. A system for calibrating a manipulator comprising:
a processor and a computer readable medium; the computer readable medium including instructions which when executed by the processor:
generates a first cloud map using depth information;
generates a second cloud map using contact information; and
recovers extrinsic parameters by aligning the first cloud map and the second cloud map.

12. The system according to claim 11, wherein the instructions include instructions for collecting the depth information.

13. The system according to claim 12, further comprising one of a depth sensor or camera to collect the depth information.

14. The system according to claim 13, wherein the depth sensor is stationary relative to a base frame of the mobile manipulator.

15. The system according to claim 11, the depth information corresponds to a rigid structure.

16. The system according to claim 15, further comprising moving an end effector of the manipulator over the rigid structure to generate the second cloud map to collect the contact information.

17. The system according to claim 15, wherein the depth information is collected from a plurality of vantage points.

18. The system according to claim 11, wherein aligning the first cloud map and the second cloud map comprises applying an iterative closest point (ICP) algorithm.

19. The system according to claim 18, further comprising accounting for kinematic model biases of the mobile manipulator when recovering the extrinsic parameters

20. The system of claim 11, wherein the manipulator is mobile.
